(19) United States
(12) Patent Application Publication
(10) Pub. No.: US 2022/0275243 A1
(43) Pub. Date: Sep. 1, 2022

(54) SURFACE FUNCTIONALIZED SUBSTRATES AND METHODS OF MAKING THE SAME

(71) Applicant: THE REGENTS OF THE UNIVERSITY OF MICHIGAN, Ann Arbor, MI (US)

(72) Inventors: Jinsang Kim, Ann Arbor, MI (US); Do Hyun Kang, Ann Arbor, MI (US)

(21) Appl. No.: 17/635,572

(22) PCT Filed: Aug. 20, 2020
(86) PCT No.: PCT/US20/47160

§ 371 Date: Feb. 15, 2022

Related U.S. Application Data
(60) Provisional application No. 62/889,341, filed on Aug. 20, 2019.

(51) Int. Cl. C09D 171/00; C08G 65/00; C09D 7/61

(52) U.S. Cl. CPC C09D 171/00; C08G 65/002; C09D 7/61

(57) ABSTRACT

Provided herein are surface-functionalized substrates and methods of making said surface-functionalized substrates.

### CROSS-REFERENCE TO RELATED APPLICATION

This application claims the benefit of priority of U.S. Provisional Patent Application No. 62/889,341 filed Aug. 20, 2019, the disclosure of which is incorporated herein by reference in its entirety.

### BACKGROUND

Immobilization of biomolecules (e.g. DNA, protein, and liposomes), nanomaterials, and macromolecules onto the solid surfaces have been widely exploited in diverse bioassays, providing various advantages. First, the bio-immobilization renders facile handling of biomolecules, particularly when altering reaction conditions (e.g. solvent or buffer solution) and/or washing the unreacted (i.e. unbound) biomolecules is required. In addition, through the bio-immobilization, efficient high-throughput analysis and long-term storage of biomolecules has been achieved. Conventionally, the immobilization is mediated by various surficial chemical groups such as amine, carboxylic acid, aldehyde, epoxy, thiol, or biotin-avidin. Amine or carboxylic groups have been widely used to tether various biomolecules (e.g. oligonucleotides, peptides, enzymes, antibodies, and cells), nanomaterials (e.g. nanoparticles and nanowires), or macromolecules (e.g. functional polymers and liposomes), due to their unique electrostatic and chemical properties. These functional groups can be strongly charged to provide electrostatic binding of biomolecules to the surfaces. Alternatively, both amine and carboxylic acid functional groups can make stable covalent bonding with various functional groups on the biomolecules. Amine functionality can be linked with an electrophilic group such as activated carboxylic acid, epoxy, and aldehyde while carboxylic acid can react with a nucleophile such as an amine after activation (e.g. carbodiimide chemistry).

There are many well-established surface functionalization strategies, such as silanization, polymer grafting, and thiol monolayer assembly. However, these methods suffer from their material-dependent limitations. For example, silanization is generally compatible with a silicon or glass surface. Polymer grafting is achieved on a polymeric surface. Thiol monolayer assembly is only applicable to a gold surface. Moreover, these methods require labor-intensive and time-consuming multiple preparation steps, often resulting in poor quality surfaces.

Thus, a need exists for methods that avoid or address these issues, for functionalizing surfaces so that biomolecules, nanomaterials, and macromolecules can be immobilized thereto.

### SUMMARY

Provided herein is a method of making a surface-functionalized substrate comprising copolymerizing a phenol monomer and a vinyl monomer in the presence of the substrate to form the polymer on the substrate surface and thereby form the surface-functionalized substrate, wherein the phenol monomer comprises two or more phenolic hydroxyl groups and the vinyl monomer comprises a carboxylic acid, or an amine, or both. In some embodiments, the phenol monomer comprises a catechol group, a galloyl group, or a combination thereof. In some embodiments, the phenol monomer comprises dopamine, tannic acid, caffeic acid, pyrogallol, gallic acid, epigallocatechin gallate, epicatechin gallate, epigallocatechin or a combination thereof. In some embodiments, the vinyl monomer comprises an acrylate monomer. In some embodiments, the acrylate monomer comprises 2-aminoethyl methacrylate, acrylic acid, or a combination thereof. In some embodiments, the copolymerizing is performed in the presence of an initiator. In some embodiments, the initiator comprises ammonium persulfate (APS), N,N,N′,N′-tetramethylethylenediamine (TEMED), or a combination thereof. In some embodiments, the substrate comprises a polymer, glass, metal, ceramic, stone, paper, fabric, carbon materials, or a combination thereof. In some embodiments, the method herein can further comprise contacting the surface functionalized substrate with a biomolecule, nanomaterial, macromolecule, or a combination thereof to immobilize the biomolecule, nanomaterial, macromolecule, or a combination thereof on the surface-functionalized substrate. In some embodiments, the biomolecule, nanomaterial, macromolecule, or a combination thereof attached via a covalent bond between the biomolecule, nanomaterial, macromolecule, or a combination thereof and a carboxylic acid or amine from the vinyl monomer. In some embodiments, the biomolecule, nanomaterial, macromolecule, or a combination thereof is functionalized to comprise a functional group that reacts with the carboxylic acid or amine prior to the contacting step. In some embodiments, the biomolecule comprises a peptide, a protein, an antibody, a oligonucleotide, an enzyme, a cell, or a combination thereof. In some embodiments, the nanomaterial comprises nanoparticles, nanowires, or a combination thereof. In some embodiments, the macromolecule comprises functional polymers, a liposome, or a combination thereof.

Also provided herein is a surface-functionalized substrate prepared by a method as described herein.

Further provided is a surface-functionalized substrate comprising a polymer coating on at least a portion of the substrate surface, wherein the polymer coating comprises a copolymerized phenol monomer and a vinyl monomer, the phenol monomer comprising two or more phenolic hydroxyl groups and the vinyl monomer comprising a carboxylic acid or an amine, or both.

In some embodiments, provided herein is a method of making a surface-functionalized substrate comprising copolymerizing a phenol monomer and a vinyl monomer in the presence of the substrate to form the polymer on the substrate surface and thereby form the surface-functionalized substrate, wherein the phenol monomer comprises two or more phenolic hydroxyl groups and the vinyl monomer comprises a carboxylic acid, or an amine, or both. In some embodiments, the phenol monomer comprises a catechol group, a galloyl group, or a combination thereof. In some embodiments, the phenol monomer comprises dopamine, tannic acid, caffeic acid, pyrogallol, gallic acid, epigallocatechin gallate, epicatechin gallate, epigallocatechin, or a combination thereof. In some specific embodiments, the phenol monomer comprises dopamine. In other specific embodiments, the phenol monomer comprises tannic acid. In some embodiments, the vinyl monomer is water soluble or alcohol soluble. In some embodiments, the vinyl monomer comprises an acrylate monomer. In some embodiments, the acrylate monomer comprises 2-aminoethyl methacrylate, acrylic acid, glycidyl methacrylate (GMA), ethylene glycol dimethacylate (EGDMA), or a combination thereof. In some embodiments, the acrylate monomer comprises 2-aminoethyl methacrylate, acrylic acid, or a combination thereof. In some specific embodiments, the acrylate monomer comprises 2-aminoethyl methacrylate. In other specific embodiments, the acrylate monomer comprises acrylic acid. In yet other specific embodiments, the acrylate monomer comprises GMA.

In some embodiments, the copolymerizing is performed in the presence of an initiator. In some embodiments, the initiator comprises ammonium persulfate (APS), N,N,N′,N′-tetramethylethylenediamine (TEMED), or a combination thereof. In some embodiments, the initiator is a photo-initiator. In some embodiments, the photo-initiator is benzophenone, 2-hydroxy-2-methylpropiophenone, or a combination thereof. In some embodiments, the photo-initiator is benzophenone.

In some embodiments, the methods described herein further comprise copolymerizing in the presence of singlet oxygen.

In some embodiments, the methods herein further comprise a base. In some embodiments, the base comprises an alkali metal hydroxide. In some embodiments, the base is sodium hydroxide. In other embodiments, the base is potassium hydroxide.

In some embodiments the substrate in the methods described herein comprises a polymer, glass, metal, ceramic, stone, paper, fabric, carbon materials, or a combination thereof. In some embodiments, the substrate is a glass slide. In other embodiments, the substrate is a glass bead.

In some embodiments, the methods described herein further comprise contacting the surface functionalized substrate with a target compound to immobilize the target compound on the surface-functionalized substrate. In some embodiments, the target compound is attached via a covalent bond between the target compound and a carboxylic acid or amine from the vinyl monomer. In some embodiments, the target compound is modified to comprise a functional group that reacts with the carboxylic acid or amine prior to the contacting step. In some embodiments, the target compound comprises a biomolecule, nanomaterial, macromolecule or a combination thereof. In some embodiments, the biomolecule comprises a peptide, a protein, an antibody, an oligonucleotide, an enzyme, a cell, or a combination thereof. In some embodiments, the biomolecule comprises an oligonucleotide. In some embodiments, the biomolecule comprises a nanomaterial. In some specific embodiments, the nanomaterial comprises nanoparticles, nanowires, or a combination thereof. In some embodiments, the biomolecule comprises a macromolecule. In some specific embodiments, the macromolecule comprises functional polymers, a liposome, or a combination thereof.

In some embodiments, provided herein is a surface-functionalized substrate prepared by the method described herein.

In some embodiments, provided herein is a surface-functionalized substrate comprising a polymer coating on at least a portion of the substrate surface, wherein the polymer coating comprises a copolymerized phenol monomer and a vinyl monomer, the phenol monomer comprising two or more phenolic hydroxyl groups and the vinyl monomer comprising a carboxylic acid or an amine, or both. In some embodiments, the phenol monomer comprises dopamine, tannic acid, caffeic acid, pyrogallol, gallic acid, epigallocatechin gallate, epicatechin gallate, epigallocatechin, or a combination thereof. In some specific embodiments, the phenol monomer comprises dopamine. In other specific embodiments, the phenol monomer comprises tannic acid. In some embodiments, the vinyl monomer is water soluble or alcohol soluble. In some embodiments, the vinyl monomer comprises an acrylate monomer. In some embodiments, the acrylate monomer comprises 2-aminoethyl methacrylate, acrylic acid, glycidyl methacrylate (GMA), ethylene glycol dimethacylate (EGDMA), or a combination thereof. In some embodiments, the acrylate monomer comprises 2-aminoethyl methacrylate, acrylic acid, or a combination thereof. In some specific embodiments, the acrylate monomer comprises 2-aminoethyl methacrylate. In other specific embodiments, the acrylate monomer comprises acrylic acid. In yet other specific embodiments, the acrylate monomer comprises GMA.

In some embodiments, the surface-functionalized substrate described herein comprises a polymer, glass, metal, ceramic, stone, paper, fabric, a carbon material, or a combination thereof. In some embodiments, the substrate comprises a glass slide or glass bead.

In some embodiments, the surface-functionalized substrate described herein further comprises a target compound attached to the surface-functionalized substrate. In some embodiments, the target compound is attached via a covalent bond between the target compound and a carboxylic acid or amine from the vinyl monomer. In some embodiments, the target compound is modified to comprise a functional group capable of reacting with the carboxylic acid or amine prior to attaching the target molecule to the surface-functionalized substrate.

In some embodiments, the target compound and the vinyl monomer are attached via a covalent bond between an amine on the target compound and a carboxylic acid on the vinyl monomer. In some embodiments, the target compound comprises a biomolecule, nanomaterial, macromolecule, or a combination thereof. In some embodiments, the biomolecule comprises a peptide, a protein, an antibody, an oligonucleotide, an enzyme, a cell, or a combination thereof. In some embodiments, the biomolecule comprises an oligonucleotide. In some embodiments, the nanomaterial comprises nanoparticles, nanowires, or a combination thereof. In some embodiments, the target compound comprises a macromolecule. In some embodiments, the macromolecule comprises functional polymers, a liposome, or a combination thereof.

### BRIEF DESCRIPTION OF FIGURES

FIG. 1 depicts a schematic for preparing a specific embodiment of a surface functionalized substrates as described herein, using polyphenol starting materials (A) with acrylates (B) in the presence of polymerization initiators (C) to co-polymerize and deposit onto the substrate surface by forming a crosslinked polymer network, wherein the polyphenol binds to the surface of the substrate and the crosslinker is between two or more polyvinyl chains.

FIG. 2 depicts a line graph of the red fluorescence intensity of the surface functionalized substrate embodiments described herein versus incubation time, wherein the effects of incubation time on the surface modification are shown.

FIG. 3 depicts a bar graph of the red fluorescence intensity of the surface functionalized substrate embodiments described herein versus the weight ratio of vinyl monomer to phenol monomer.

FIG. 4 depicts a reaction scheme of a photoinitiator reacting with oxygen to produce singlet oxygen and the singlet oxygen reacting with dopamine to cyclize and polymerize the dopamine to polydopamine.

### DETAILED DESCRIPTION

Provided herein are surface-functionalized substrates and methods of making surface-functionalized substrates. The surface-functionalized substrate can comprise a polymer coating on at least a portion of the substrate surface. In some embodiments, the polymer coating can comprise a polymerized phenol monomer and a vinyl monomer. In some embodiments, the phenol monomer can comprise two or more phenolic hydroxyl groups. In some embodiments, the vinyl monomer can comprise a carboxylic acid or an amine. In some embodiments, the vinyl monomer can be water soluble or alcohol soluble.

The surface-functionalized substrates are prepared by copolymerizing a phenol monomer and a vinyl monomer in the presence of the substrate to form the polymer on the substrate surface and thereby form the surface-functionalized substrate.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The use of the terms “a,” “an,” “the,” and similar referents in the context of the disclosure herein (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure herein and is not a limitation on the scope of the disclosure herein unless otherwise indicated. No language in the specification should be construed as indicating any non-claimed element as essential to the practice of the disclosure herein.

### Surface-functionalized Substrates

The disclosure provides a surface-functionalized substrate comprising a polymer coating on at least a portion of the substrate surface. The polymer coating can comprise a copolymerized phenol monomer and a vinyl monomer.

The phenol monomer can comprise two or more phenolic hydroxyl groups. For example, the phenol monomer can comprise a galloyl group, a catechol group, or a combination thereof. As used herein, the term “galloyl group” comprises a structure

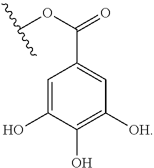 [SMILES: *OC(=O)c1cc(O)c(O)c(O)c1]

As used herein, the term “catechol group” comprises a 1,2-dihydroxybenzene. The galloyl group and catechol group used herein can be further substituted. In some embodiments, the phenol monomer can comprise dopamine, tannic acid, caffeic acid, pyrogallol, gallic acid, epigallocatechin gallate, epicatechin gallate, epigallocatechin, or a combination thereof. In some embodiments, the phenol monomer can comprise dopamine. In some embodiments, the phenol monomer can comprise tannic acid.

In some embodiments, the vinyl monomer can be solvent-soluble, wherein the vinyl monomer is capable of being dissolved in a solvent. In some embodiments, the vinyl monomer can be water soluble or alcohol soluble. As used herein, the term “water soluble or alcohol soluble” refers to a compound being soluble in water, methanol, ethanol, propanol, butanol, or the like, at temperatures ranging from 15° C. to 30° C. and a pressure of 1 atm.

In some embodiments, the vinyl monomer can be used to provide various polymer coatings, such as, for example, a hydrophilic polymer coating, a hydrophobic polymer coating, a functional polymer coating, a stimuli-responsive polymer coating, and an antibacterial polymer coating. As used herein, the term “functional polymer coating” refers to a polymer coating having additional functional groups that are capable of further conjugating with biomolecules. For example, the functional polymer coating can include functional groups, such as, an amine, carboxylic acid, epoxy, aldehyde, biotin, or a combination thereof. As used herein, the term “stimuli-responsive polymer coating” refers to a polymer coating having polymer chains that are capable of changing properties based on environmental changes. Environmental changes include, for example, temperature changes and pH changes. For example, poly(N-isopropylacrylamide) can change its wetting behavior by temperature change (e.g., poly(N-isopropylacrylamide) is hydrophilic below 32° C. and is hydrophobic above 32° C. In some embodiments, the hydrophilic polymer coating can comprise a vinyl monomer comprising polyethylene glycol acrylate, polyethylene glycol methacrylate, polyethylene glycol diacrylate, polyethylene glycol triacrylate, polyethylene glycol dimethacrylate, polyethylene glycol trimethacrylate, (hydroxyethyl) methacrylate, or a combination thereof. In some embodiments, the hydrophobic polymer coating can comprise a vinyl monomer comprising perfluoropolyether acrylate, perfluoropolyether diacrylate, C₁₂₋₄₀ acrylates (e.g., octadecyl acrylate and lauryl acrylate), C₁₂₋₄₀ methacrylates, or a combination thereof. In some embodiments, the functional polymer coating can comprise a vinyl monomer comprising aminoethyl methacrylate. In some embodiments, the stimuli-responsive coating can comprise a vinyl monomer comprising N-isopropylacrylamide, acrylic acid, 2-(Dimethylamino)ethyl methacrylate, or a combination thereof. In some embodiments, the antibacterial polymer coating can comprise a vinyl monomer comprising sulfobetaine methacrylate, [2-(methacryloyloxy)ethyl]dimethyl-(3-sulfopropyl)ammonium hydroxide, 2-methacryloyloxyethyl phosphorylcholine, or a combination thereof.

In some embodiments, the vinyl monomer can comprise acrylamides such as acrylamide and methacrylamide; dialkylaminoalkyl acrylamides, such as dimethylaminoethyl acrylamide; acrylates such as acrylic acid and methacrylic acid; dialkylaminoalkyl acrylates, such as dimethylaminoethyl acrylate and dimethylaminoethyl methacrylate; vinyl pyridine; methyl vinyl pyridine; vinyl pyrrolidone; amino styrenes such as p-dimethylaminomethyl styrene; vinyl sulfuric acid; trimethyl ammonium ethyl acrylate (chloride); glycidyl acrylates or glycidyl alkylacrylates such as glycidyl methacrylate (GMA); glycol acrylates such as ethylene glycol dimethacrylate (EGDMA); or a combination thereof.

In some embodiments, the vinyl monomer can comprise a carboxylic acid or an amine or both, and can be water soluble or alcohol soluble. In some embodiments, the vinyl monomer can comprise an acrylate monomer. In some embodiments, the acrylate monomer can comprise a carboxylic acid, an amine, or a combination thereof. In some embodiments, the acrylate monomer can comprise acrylic acid, methacrylate, ethyl acrylate, propyl acrylate, a butyl acrylate, or a combination thereof. In some embodiments, the acrylate monomer can comprise 2-aminoethyl methacrylate (AEMA), acrylic acid (AA), or a combination thereof. In some embodiments, the acrylate monomer can comprise 2-aminoethyl methacrylate (AEMA), acrylic acid (AA), glycidyl methacrylate, ethylene glycol dimethacrylate, or a combination thereof. In some embodiments, the acrylate monomer comprises AEMA. In some embodiments, the acrylate monomer comprises AA. In some embodiments, the acrylate monomer comprises GMA. In some embodiments, the acrylate monomer comprises EGDMA. In some embodiments, the acrylate monomer comprises GMA and EGDMA.

Without intending to be bound by theory, the phenol monomer having a catechol group, such as dopamine, can crosslink with the acrylate monomer, such as AEMA, through Michael addition or Schiff base formation, or radical scavenging reactions. In a similar manner, the phenol monomer having a galloyl group, such as on tannic acid, can crosslink with an acrylate monomer, such as AEMA, through Michael addition or Schiff base formation or radical scavenging reactions.

As used herein, the substrate can comprise a solid substrate or a porous substrate. In some embodiments, the substrate can comprise ceramic, glass, metal, polymer, stone, paper, fabric, a carbon material, or a combination thereof. As used herein, the term “carbon materials” refer to elemental carbon materials, such as graphite, carbon fiber, carbon nanotube, graphene, carbon black, activated carbon, fullerene and diamond. In some embodiments, the substrate can comprise glass, such as a glass slide or a glass bead. The glass bead can have any suitable diameter. For example in some embodiments, the glass bead has a diameter of 400 to 600 μm, or about 500 μm. In some embodiments, the substrate can be a medical device, or more specifically, a stent.

In some embodiments, the surface-functionalized substrate can further comprise a biomolecule, nanomaterial, macromolecule, or a combination thereof. In some embodiments, the biomolecule herein can comprise a peptide, a protein, an antibody, an enzyme, an oligonucleotide, a cell, or a combination thereof. In some embodiments, the biomolecule can comprise an oligonucleotide. In some embodiments, the nanomaterial herein can comprise nanoparticles, nanowires, or a combination thereof. In some embodiments, the macromolecule herein can comprise functional polymers, liposomes, or a combination thereof. In some embodiments, the biomolecule, the nanomaterial, the macromolecule, or a combination thereof can be attached to the surface-functionalized substrate via a covalent bond between the biomolecule, nanomaterial, macromolecule, or a combination thereof and a carboxylic acid or amine from the acrylate monomer.

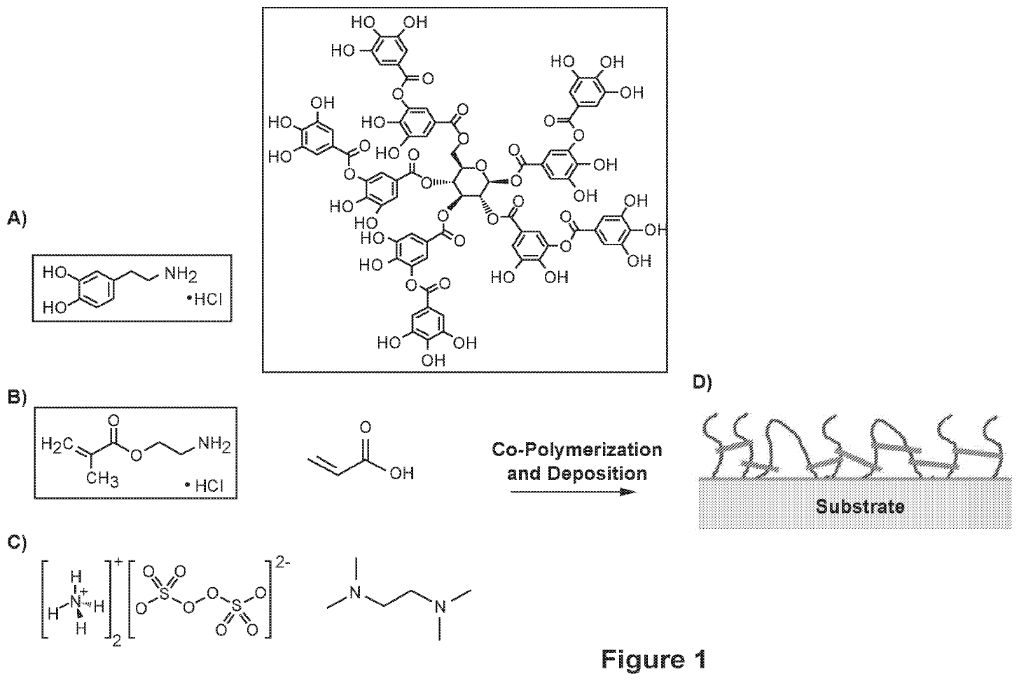

The surface functionalized substrate herein comprises a crosslinked polymer network on their surface, comprising a polyphenol component and a polyvinyl component. The polyphenol component can play two important roles: binding to the surface of the substrate (e.g., via pi-bonds and/or hydrogen bonds) and the crosslinker between two or more polyvinyl chains (FIG. 1). In some embodiments, the resulting crosslinked polymer network creates a resulting surface having an abundant amount of amine and carboxylic acid groups three-dimensionally, in contrast to other two-dimensional techniques such as silanization. These amine and carboxylic acid groups arranged in a 3D manner provide a high density of points of attachment to immobile a target compound of interest.

In some embodiments, the surface functionalized substrates as described herein can be useful for surface immobilization of analytes within biosensors. In some embodiments, the surface functionalized substrates as described herein can be useful to produce assay plates, microarray chips, and protein purification resins by immobilizing materials directly or in conjugation of relevant receptors. In some embodiments, the surface functionalized substrates as described herein can be useful for biocompatible coatings for medical devices and implants. The ability to incorporate distinct chemical functionalities by modifying the composition of the vinyl monomer could provide a mechanism for the conjugation of drug molecules to the material surface. For example, anti-coagulants could be applied to the surface of cardiac stents to improve their long-term ability to prevent arterial blockages. In some embodiments, the surface functionalized substrates as described herein can be useful for drug delivery applications by providing the opportunity for reversible conjugation chemistries for attaching drug molecules for a sustained, slow release of therapeutics.

### Method of Making the Disclosed Substrates

Provided are methods of making a surface-functionalized substrate. The methods of making the surface-functionalized substrate can comprise copolymerizing a phenol monomer and a vinyl monomer in the presence of the substrate to form the polymer on the substrate surface and thereby form the surface-functionalized substrate. In some embodiments, the phenol monomer can comprise two or more phenolic hydroxyl groups, such as dopamine or tannic acid. In some embodiments, the vinyl monomer can comprise a carboxylic acid, or an amine, or both, and can be water soluble or alcohol soluble.

In some embodiments, the copolymerizing can be performed in the presence of an initiator. The initiator can initiate polymerization, such as the copolymerization of monomers via a radical polymerization. In some embodiments, the initiator can comprise an oxidant, a base, or a combination thereof. In some embodiments, the initiator can comprise halogens, azo compounds, organic peroxides, inorganic peroxides, phenones, or a combination thereof. In some embodiments, the initiator can comprise ammonium persulfate (APS), N,N,N′,N′-tetramethylethylenediamine (TEMED), benzophenone, 2-hydroxy-2-methylpropiophenone (HMPP), or a combination thereof. In some embodiments, the initiator can comprise ammonium persulfate (APS), N,N,N′,N′-tetramethylethylenediamine (TEMED), or a combination thereof. In some embodiments, the initiator can initiate polymerization thermally, under ambient conditions or a combination thereof. In some embodiments, the initiator can initiate polymerization photocatalytically, such as with ultra-violet (UV) light. In some embodiments, the initiator can further comprise oxygen (³O₂), singlet oxygen (¹O₂*) or a combination thereof. In some embodiments, the initiator can comprise singlet oxygen, UV light, and benzophenone. In some embodiments, the initiator can comprise singlet oxygen, UV light, and HMPP. In some embodiments, the initiator can be a base. In some embodiments, the base can comprise an alkali metal hydroxide. In some embodiments, the alkali metal hydroxide can comprise Li, Na, K, Cs, or Rb. In some embodiments, the base comprises NaOH.

In some embodiments, the method herein can be performed in a one pot reaction, wherein the phenol monomer, the vinyl monomer, and the initiator are mixed together, and said mixture is then loaded onto the surface of the substrate thereby forming the surface-functionalized substrate. In some embodiments, after the mixture is loaded onto the surface of the substrate, the surface-functionalized substrate can be incubated. In some embodiments, the surface-functionalized substrate can be incubated for about 1 minute to about 48 hours, or about 5 minutes to about 24 hours, or about 10 minutes to about 24 hours, or about 15 minutes to about 24 hours, or about 20 minutes to about 24 hours, or about 30 minutes to about 24 hours, about 1 hour to about 48 hours, about 1 hour to about 24 hours, or about 1 hour to about 18 hours, or about 4 hours to 24 hours, or about 4 hours to about 18 hours. In some embodiments, the surface-functionalized substrate can be incubated for about 1 minute, 5 minutes, 10 minutes, 15 minutes, 20 minutes, 30 minutes, 45 minutes, 1 hour, 2 hours, 3 hours, 4 hours, 5 hours, 6 hours, 7 hours, 8 hours, 9 hours, 10 hours, 15 hours, 18 hours, 20 hours, 24 hours, 30 hours 40 hours, or 48 hours. In some embodiments, the incubation temperature can be from about 0° C. to about 80° C., or about 0° C. to about 50° C., or about 0° C. to about 35° C., or about 0° C. to about 25° C., or about 5° C. to about 50° C., or about 5° C. to about 25° C. In some embodiments, the incubation temperature can be 0° C., 5° C., 10° C., 15° C., 20° C., 25° C., 30° C., 35° C., 40° C., 50° C., 60° C., 70° C., or 80° C. In some embodiments, after the mixture is loaded onto the surface of the substrate, the surface-functionalized substrate can be irradiated with light. In some embodiments, the light can be UV light (e.g., a wavelength of 365 nm or 254 nm wavelength). In some embodiments, the surface-functionalized substrate can be irradiated for about 1 minute to about 1 hour, or about 5 minutes to about 1 hour, or about 10 minutes to about 1 hour, or about 15 minutes to about 1 hour, or about 20 minutes to about 1 hour, or about 30 minutes to about 1 hour.

Following incubation, in some embodiments, the surface-functionalized substrates can be washed with a solvent and dried. In some embodiments, the washing solvent can comprise water, methanol, ethanol, propanol (e.g., n-propanol or isopropanol) or butanol (e.g., tert-butanol, sec-butanol, iso-butanol, or n-butanol).

In some embodiments, the method of making a surface-functionalized substrate can further comprise contacting the surface-functionalized substrate with a target compound to immobilize said target compound on the surface-functionalized substrate. As used herein, the target compound can be a biomolecule, drug molecules, macromolecules, nanomaterials, or a combination thereof. The target compound can be immobilized through non-covalent interactions (e.g., ionic bonds, hydrogen bonds, pi-stacking) with the surface-functionalized substrate or through covalent bonds. In some embodiments, the target compound can be a compound that is able to form a covalent bond to a carboxylic acid or amine from the vinyl monomer; for example, the target compound can comprise a carboxylic acid, amine, epoxy, aldehyde or a combination thereof. In some embodiments, the target compound can be a compound that is able to form a covalent bond to a carboxylic acid or amine from the vinyl monomer; for example, the target compound can comprise a carboxylic acid, epoxy, aldehyde or a combination thereof. In some embodiments, the target compound can comprise an amine. In some embodiments, the method can further comprise contacting the surface-functionalized substrate with a biomolecule to immobilize the biomolecule on the surface-functionalized substrate. In some embodiments, the biomolecule can be attached via a covalent bond between the biomolecule and a carboxylic acid or amine from the vinyl monomer. In some embodiments, the target compound and the vinyl monomer are attached via a covalent bond between the target compound comprising an amine and the vinyl monomer comprising a carboxylic acid.

In some embodiments, the target compound (e.g., biomolecule) can be used directly, contacting the surface of the surface functionalized substrate or in some embodiments, the target compound (e.g., biomolecule) may need to be pretreated prior to contacting the surface of the surface functionalized substrate. In some embodiments, the pretreatment of the target compound prior to contacting the surface functionalized substrate can comprise the addition of an activating agent. The activating agent herein can be used to facilitate the reaction of the target compound (e.g., biomolecule) with the carboxylic acid or amine of the vinyl monomer. In some embodiments, the activating agent can comprise N-hydroxysuccinimide (NHS), 1-ethyl-3-(3-dimethylaminopropyl)-carbodiimide (EDC), or a combination thereof. In some embodiments, the activating agent can facilitate a reaction of the target compound comprising an amine and the surface-functionalized substrate comprising a carboxylic acid.

After the addition of the target compound (e.g., biomolecule) to the surface functionalized substrate, the surface functionalized substrate with the target compound (e.g., biomolecule) attached can be incubated. In some embodiments, the incubation can be for about 30 minutes to about 5 hours, or about 1 hour to about 3 hours or about 1 hour to about 2 hours. In some embodiments, the incubation temperature can be from about 0° C. to about 80° C., or about 0° C. to about 50° C., or about 0° C. to about 35° C., or about 0° C. to about 25° C., or about 5° C. to about 50° C., or about 5° C. to about 25° C. In some embodiments, the incubation temperature can be 0° C., 5° C., 10° C., 15° C., 20° C., 25° C., 30° C., 35° C., 40° C., 50° C., 60° C., 70° C., or 80° C.

Following incubation, the surface functionalized substrate can be washed with a solvent in order to remove any unbound target compound (e.g., biomolecule). In some embodiments, the solvent can comprise water, methanol, ethanol, propanol or butanol.

### EXAMPLES

### Materials

Dopamine, tannic acid, ammonium persulfate (APS), N,N,N′N′-tetramethylethylenediamine (TEMED), 2-aminoethyl methacrylate (AEMA), and acrylic acid (AA) were purchased from the Sigma-Aldrich. The other chemicals, such as solvents and buffers were also purchased from the Sigma-Aldrich. Polydiacetylene (PDA) monomers, 10,12-pentacosadiynoic acid (PCDA)-epoxy and PCDA-NH₂ were synthesized according to known synthetic methods. A phospholipid, 1,2-dimyristoyl-sn-glycero-3-phosphate (DMPA) was ordered from Avanti Polar Lipids. The 96 well plates were purchased from Greiner Bio-one and were used directly without washing. Glass slides were obtained from Fisher Scientific and were bath-sonicated in chloroform for 5 minutes, acetone for 5 minutes, and 2-propanol for 5 minutes to clean the surface before the surface modification.

### Example 1

Deposition and Polymerization of 2-Aminoethyl Methacrylate (AEMA) with Dopamine or Tannic acid: For the polydopamine-assisted deposition of polyAEMA, 2 mg of dopamine, 1.2 mg of APS, 1.2 mg of TEMED, 100 mg of AEMA, and 900 mg of DI water were mixed freshly before every experiment. The AEMA solution was homogenized by 120 W probe-sonication for 10 mins and was filtrated through syringe filter or cotton wool prior to the mixing. The mixture was loaded onto a cleaned slide glass or 96 well plate (100 μl ). After 5 hrs of incubation, the surfaces were washed with DI water thoroughly and dried with air.

In the tannic acid-based deposition, 2 mg of tannic acid, 1.2 mg of APS, 1.2 mg of TEMED, 100 mg of AEMA, 900 mg of DI water, and 50 μl of acetic acid were mixed freshly before every experiment. Acetic acid is added to inhibit the formation of insoluble ionic complex between tannic acid and TEMED. The mixture was loaded to the cleaned slide glass. After overnight incubation, the surfaces were washed with DI water thoroughly and dried with air.

Deposition and Polymerization of Acrylic acid (AA) with Dopamine or Tannic Acid: 2 mg of dopamine (or tannic acid), 1.2 mg of APS, 1.2 mg of TEMED, 50 μl of AEMA, and 900 μl of DI water were mixed freshly before every experiment. The mixture was loaded to the cleaned slide glass or 96 well plate (100 μl ). After overnight incubation, the surfaces were washed with DI water thoroughly and dried with air.

### Example 2

Assembly of Polydiacetylene (PDA)-Epoxy Liposome and PDA-NH₂ Liposome: The PDA-epoxy liposomes and PDA-NH₂ liposomes were prepared by the following injection method of known procedures. For the assembly of the PDA-epoxy liposome, PCDA-epoxy and DMPA were co-dissolved (4:1 molar ratio) in the 0.1 ml of tetrahydrofuran/water mixture (9:1 v/v) and the organic lipid solution was injected to the 20 ml of 5 mM HEPES buffer pH 8. The total lipid concentration in the final aqueous solution was 0.5 mM. The liposome solution was homogenized by 120 W probe-sonication for 10 min and was filtrated through a 0.8 μm cellulose acetate syringe filter. The filtrated solution was incubated at 5° C. overnight and was used within a day.

The PDA-NH₂ liposomes were self-assembled by injecting the THF/water mixture (9:1 v/v) containing PCDA-NH₂ to the 20 ml of DI water or 5 mM HEPES solution pH 5.6. The total lipid concentration in the final aqueous solution is 1 mM. The liposome solution was probe-sonicated with 120 W for 10 min and was filtrated through 0.8 μm cellulose acetate syringe filter. The filtrated solution was incubated at 5° C. overnight and was used within a day.

Immobilization of PDA Liposomes to the amine or carboxylic acid surfaces: The PDA-epoxy liposomes (0.5 mM) were used directly without any pre-treatment while the PDA-NH₂ liposomes (1 mM) were mixed with the same volume of the solution containing 1 mM of NHS (N-hydroxysuccinimide) and 1 mM of EDC (1-ethyl-3-(3-dimethylaminopropyl)-carbodiimide) before the covalent conjugation with carboxylic acid groups. The PDA liposomes were loaded onto the surface functionalized substrates and incubated for 1 hrs. After washing the unbound liposomes with DI water, the immobilized PDA liposomes were polymerized by 1 min of 254 nm UV irradiation (1 mW/cm⁻²). For the fluorescence-based analysis, the polymerized blue PDA liposomes were covered to the fluorescent red PDA liposomes by 5 mins of heating at 100° C. The red fluorescence images were obtained on Olympus BX 51 microscope and analyzed by NIH ImageJ Program.

### Example 3

One-Pot Deposition and Polymerization of 2-Aminoethyl Methacrylate (AEMA) with Dopamine: Four different surfaces were prepared and denoted as pristine surfaces, polydopamine surfaces, polyAEMA surfaces and polydopamine/polyAEMA surfaces, respectively. The polydopamine/polyAEMA surfaces were incubated with the mixture of the AEMA, Dopamine, APS, TEMED, and DI water, while the polydopamine surfaces were prepared with the dopamine solution containing no AEMA. The polyAEMA surfaces were fabricated by exposing the pristine surface to the mixture of AEMA, APS, TEMED, and DI water. The color of both solutions for the polydopamine surface and polydopamine/AEMA surface became dark brown, indicating the formation of polydopamine. After overnight incubation and thorough washing, the color of the polydopamine surface was found to be much darker than polydopamine/polyAEMA surfaces. It is reasonably explained that the conjugation length of polydopamine is reduced due to the reactions between amine and catechol (e.g., Michael addition or Schiff base formation) or the radical scavenging reactions. The light-colored polydopamine/polyAEMA surface is beneficial to bio-imaging applications.

The three prepared surfaces (excluding the pristine surfaces) were further incubated with the polydiacetylene liposomes having epoxy headgroups (PDA-epoxy liposomes) over the course of 1 hour to check the degree of amine modification by the amine-epoxy reactions. The polydiacetylene liposomes originally have blue color, and can convert its color from blue to red when exposed to external stimuli such as heating or binding of biomolecules. In addition, the converted red PDA liposomes can emit red fluorescence while the original blue PDA liposomes have no emission. The PDA liposomes were successfully attached to the polydopamine/polyAEMA surfaces through the amine-epoxy chemistry while no fluorescence signal was observed on the pristine surface, the polydopamine surface, and the polyAEMA surface. The uniform red fluorescence also indicates that the uniformity of this method. As compared with the conventional silanization method, the methods disclosed herein show much stronger and more uniform signal. The disclosed methods herein were also readily applied to the spherical glass beads (Diameter: ˜500 um), as well as the flat glass surfaces.

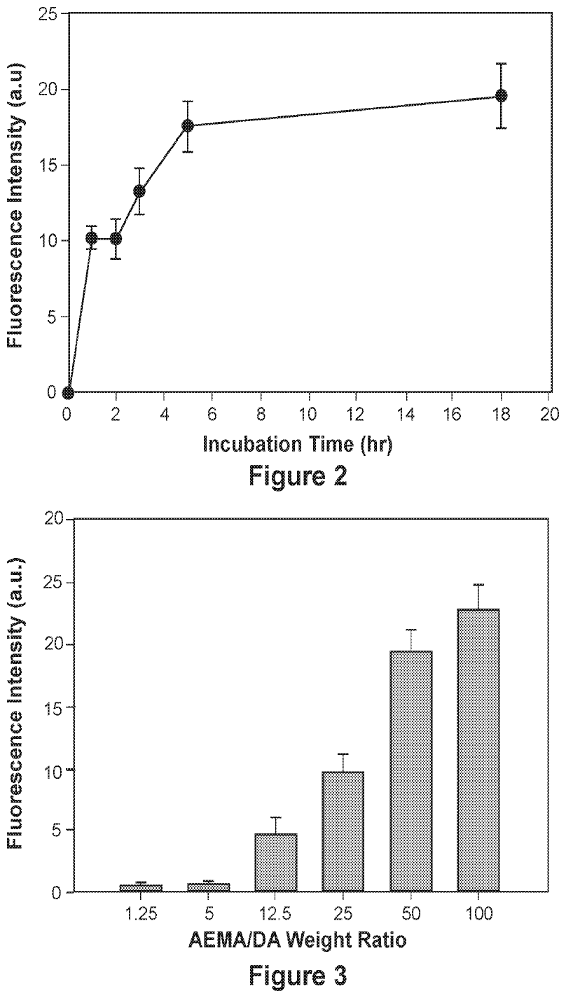

Effect of Incubation Time and AEMA/Dopamine Ratio for Amine Modification: Additionally, the effect of incubation time on the amine modification was investigated. As the incubation time increased, the red fluorescence intensity of the PDA liposomes was also enhanced (FIG. 2). Without intending to be bound by theory, as the incubation time increased, the number of the surficial amine groups were increased through the polymerization of AEMA and the crosslinking with polydopamine. The fluorescence intensity was dramatically increased for 3 hours and slowly increased after 5 hrs as shown in FIG. 2.

The effect of the ratio between AEMA and dopamine on the amine modification was also observed herein. The red fluorescence intensity was decreased as the weight ratio between AEMA and DA was reduced (FIG. 3). Below a ratio of AEMA to DA of 5 to 1, the red fluorescence intensity was not observed, indicating that the binding of PDA-epoxy liposomes was inefficient.

Tannic Acid-Based Amine Modification: Tannic acid was also tested as a surface binder and crosslinker of polyAEMA chains, in the same manner as dopamine seen above. In such tannic acid-based method, acetic acid was added additionally to prevent the formation of insoluble ionic complex between tannic acid and TEMED. After the surface modification, PDA-epoxy liposomes were loaded onto the functionalized surfaces. The PDA-epoxy liposome was attached to the only polyAEMA/tannic acid surfaces, showing good compatibility with tannic acid. As shown in the dopamine examples, the red fluorescence intensity was tested and compared to a pristine surface and a surface functionalized by tannic acid alone.

### Example 4

Carboxylic Acid Modification with Acrylic Acid: The method was further tested by replacing the AEMA monomer with acrylic acid. Dopamine-based deposition of the polyacrylic acid was attempted. Without out being bound by theory, it is believed that the propagating radicals on the polyAA chain can bind to the polydopamine through radical scavenging reactions, forming a crosslinked network consisting of polyAA and polydopamine. Due to the lowered pH by acrylic acid, the incubation time was increased to overnight (or ˜18 hrs) as compared with 5 hrs of the amine modification. As shown in the previous examples, the red fluorescence intensity was tested and compared to a pristine surface and a surface functionalized by tannic acid alone.

After preparation of the polyAA/polydopamine surfaces, the PDA-NH₂ liposomes were loaded onto the polyAA/polydopamine surfaces with NHS and EDC molecules. It is believed the NHS and EDC induces the covalent amide linkage between the PDA-NH₂ liposomes and the carboxylic acid surfaces. The PDA-NH₂ liposomes were attached to only the polyAA/polydopamine surfaces, indicating the extensibility of the disclosed methods. In the same manner, the tannic acid-based acrylic acid modification also was successfully confirmed. As shown in the previous examples, the red fluorescence intensity was tested and compared to a pristine surface and a surface functionalized by tannic acid alone.

The polyAA/polydopamine surfaces are loaded with an amine containing oligonucleotide (e.g., DNA, PNA, LNA, RNA, primers, aptamers, peptides, proteins, etc.) and NHS and/or EDC molecules. The oligonucleotides are attached to only the polyAA/polydopamine surfaces.

### Example 5-Dopamine Polymerization and Deposition with NaOH (or KOH) in MeOH

A solution of dopamine (10.5 mM) in methanol and 15 mM NaOH or KOH solution were mixed and left to sit. This solution was newly prepared for every experiment. The resulting film was assessed after one hour. The target substrate was immersed in the dopamine/methanol solution and was incubated for one hour. Rapid polymerization and deposition of dopamine occurred with use of methanol, compared to aqueous conditions (dopamine in 10 mM tris buffer) at pH 8.5). A much thicker and/or darker film was formed when methanol with NaOH or KOH was used, compared to the conventional aqueous solution-based condition (tris buffer). It is hypothesized that improved solubility of the formed polydopamine in MeOH allows for faster polymerization and thicker and/or darker film formation.

### Example 6-Photocatalytic Polymerization of Dopamine

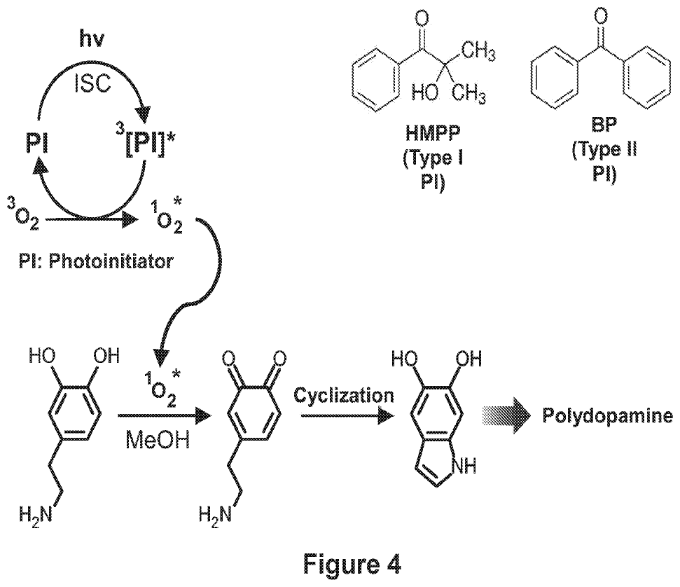

Oxidative polymerization of dopamine and tannic acid was investigated by singlet oxygen generated by photo-initiators (FIG. 4). A number of photo-initiators were investigated, but only benzophenone, a Type II photo-initiator, provided for noticeable film deposition on a substrate. HMPP, DMPA, and DBTPO initiators did not result in film deposition to the extent that benzophenone did. Dopamine (10.5 mM=2 mg/ml) was dissolved in methanol containing 305 mM of photo-initiators (BP, HMPP, DMPA, and DBTPO). This solution was prepared freshly in every experiment. The target substrate was immersed in the dopamine/methanol solution and was monitored for one day.

### Example 7-Presence of Oxygen

Polymerization of dopamine was assessed in the presence or absence of oxygen. A sample of dopamine, NaOH (10.5 mM), benzophenone (150 mM), and methanol was irradiated with 365 nm UV handlamp, while another sample first purged with argon gas for 10 minutes before irradiation. After overnight exposure to the UV light, only the sample that contained oxygen formed a film.

### Example 8-Presence of Sodium Hydroxide

Samples of dopamine (2 mg/mL) with benzophenone or HMPP as photo-initiator (150 mM) in the presence or absence of 15 mM NaOH were irradiated for 10 minutes and film formation was assessed. NaOH accelerates the photo-chemistry by providing oxidative basic conditions. While UV irradiation (4 W, 365 nm or 254 nm) induced fast polydopamine formation when benzophenone was used in MeOH with NaOH, the same UV irradiation prevented the polymerization when HMPP, a type I photo-initiator was used in the same condition.

### Example 9-One-Pot Deposition and Polymerization of Glycidyl Methacrylate with Tannic Acid

Tannic acid (10 mg), glycidyl methacrylate (GMA) (200 μL), HMPP as photo-initiator (10 μL), in methanol (0.8 mL) were mixed together and irradiated with UV light (4 W, 365 nm or 254 nm) for 10 minutes, then washed with methanol. The resulting film was an expoxy-functionalized surface that could be used for further modification. For example, the resulting material was incubated for 20 minutes with PCDA-NH2 liposome, and irradiated with UV light (254 nm) for 1 min.

### Example 10-One-Pot Deposition and Polymerization of Glycidyl Methacrylate and Ethylene Glycol Dimethacrylate with Tannic Acid:

Tannic acid (10 mg), glycidyl methacrylate (GMA, 200 μL), ethylene glycol dimethacrylate (EGDMA, 100 μ L), HMPP as photo-initiator (10 μL) were mixed together in 0.7 mL of methanol and irradiated for 10 min with UV light (365 nm), then washed with methanol. The resulting film was then further modified by incubating for 20 min with PCDA-NH2 liposomes and irradiated with UV light (254 nm) for 1 min.

1. A method of making a surface-functionalized substrate comprising
copolymerizing a phenol monomer and a vinyl monomer in the presence of a substrate to form a polymer on a surface of the substrate and thereby form the surface-functionalized substrate, wherein the phenol monomer comprises two or more phenolic hydroxyl groups and the vinyl monomer comprises a carboxylic acid, or an amine, or both.

2. The method of claim 1, wherein the phenol monomer comprises a catechol group, a galloyl group, or a combination thereof.

3. The method of claim 2, wherein the phenol monomer comprises dopamine, tannic acid, caffeic acid, pyrogallol, gallic acid, epigallocatechin gallate, epicatechin gallate, epigallocatechin, or a combination thereof.

4. (canceled)

5. (canceled)

6. (canceled)

7. The method of claim 1, wherein the vinyl monomer comprises an acrylate monomer.

8. The method of claim 7, wherein the acrylate monomer comprises 2-aminoethyl methacrylate, acrylic acid, glycidyl methacrylate (GMA), ethylene glycol dimethacylate (EGDMA), or a combination thereof.

9. (canceled)

10. (canceled)

11. (canceled)

12. (canceled)

13. (canceled)

14. Currently Amended) The method of claim 1, wherein the copolymerization is performed in the presence of an initiator and the initiator comprises ammonium persulfate (APS), N,N,N′,N′-tetramethylethylenediamine (TEMED), or a combination thereof.

15. (canceled)

16. The method of claim 1, wherein the copolymerization is performed in the presence of a photo-initiator and the photo-initiator is benzophenone, 2-hydroxy-2-methylpropiophenone, or a combination thereof.

17. (canceled)

18. The method of claim 1, further comprising copolymerizing in the presence of singlet oxygen.

19. (canceled)

20. The method of claim 1, further comprising a base, wherein the base comprises an alkali metal hydroxide.

21. The method of claim 20, wherein the base is sodium hydroxide or potassium hydroxide.

22. (canceled)

23. (canceled)

24. (canceled)

25. The method of claim 1, further comprising contacting the surface-functionalized substrate with a target compound to immobilize the target compound on the surface-functionalized substrate, wherein the target compound is attached via a covalent bond between the target compound and a carboxylic acid or amine from the vinyl monomer.

26. The method of claim 25, wherein the target compound is modified to comprise a functional group that reacts with the carboxylic acid or amine prior to the contacting step.

27. The method of claim 25, wherein the target compound comprises a biomolecule, nanomaterial, macromolecule or a combination thereof.

28. (canceled)

29. (canceled)

30. (canceled)

31. (canceled)

32. A surface-functionalized substrate prepared by the method of claim 1.

33. A surface-functionalized substrate comprising a polymer coating on at least a portion of the substrate surface, wherein the polymer coating comprises a copolymerized phenol monomer and a vinyl monomer, the phenol monomer comprising two or more phenolic hydroxyl groups and the vinyl monomer comprising a carboxylic acid or an amine, or both.

34. The surface-functionalized substrate of claim 33, wherein the phenol monomer comprises dopamine, tannic acid, caffeic acid, pyrogallol, gallic acid, epigallocatechin gallate, epicatechin gallate, epigallocatechin, or a combination thereof.

35. (canceled)

36. (canceled)

37. (canceled)

38. The surface-functionalized substrate of claim 33, wherein the vinyl monomer comprises an acrylate monomer.

39. The surface-functionalized substrate of claim 38, wherein the acrylate monomer comprises 2-aminoethyl methacrylate, acrylic acid, GMA, EGDMA, or a combination thereof.

40. (canceled)

41. (canceled)

42. (canceled)

43. (canceled)

44. (canceled)

45. (canceled)

46. (canceled)

47. The surface-functionalized substrate of claim 33, further comprising a target compound attached to the surface-functionalized substrate, wherein the target compound is attached via a covalent bond between the target compound and the carboxylic acid.

48. The surface-functionalized substrate of claim 47, wherein the target compound is modified to comprise a functional group capable of reacting with the carboxylic acid or the amine prior to attaching the target molecule to the surface-functionalized substrate, or wherein the target compound and the vinyl monomer are attached via a covalent bond between an amine on the target compound and the carboxylic acid on the vinyl monomer.

49. (canceled)

50. (canceled)

51. (canceled)

52. (canceled)

53. (canceled)

54. (canceled)
